(19) United States
(12) Patent Application Publication
(10) Pub. No.: US 2026/0141920 A1
(43) Pub. Date: May 21, 2026

(54) VIDEO PLAYBACK APPARATUS AND RECORDING MEDIUM

(71) Applicant: AlphaTheta Corporation, Kanagawa (JP)

(72) Inventors: Masahiro KONDO, Kanagawa (JP); Yuki MURATA, Kanagawa (JP)

(21) Appl. No.: 19/393,069

(22) Filed: Nov. 18, 2025

(30) Foreign Application Priority Data
Nov. 19, 2024 (JP) 2024-201588

(51) Int. Cl. G11B 27/00; G11B 27/34; H04N 21/431

(52) U.S. Cl. CPC G11B 27/007; G11B 27/34; H04N 21/4312

(57) ABSTRACT

A video playback apparatus includes a processor configured to set a parameter related to a playback state of a first video, and control a playback state of a second video different from the first video in a display mode including a mode in which the first video and the second video are simultaneously displayed based on setting of the parameter, wherein playback timings of the first video and the second video are identified by time codes of the same music.

### CROSS-REFERENCE TO RELATED APPLICATION

The present application claims priority to and incorporates by reference the entire contents of Japanese Patent Application No. 2024-201588 filed in Japan on Nov. 19, 2024.

### FIELD

The present invention relates to a video playback apparatus and a video playback program.

### BACKGROUND

In various sports, a motion to be performed in sports is practiced. For example, in an example of a dance, practice is performed by using, as a model, dance choreography performed by an instructor.

Practicing a motion requires a player to remember a motion as a model and to perform the motion by the player himself/herself. In this respect, practice is performed by trial and error while a model video in which a model motion is captured or a practice video in which a motion of the player himself/herself is captured is played back by a media player.

When a video is played back by a media player in this manner, a function of controlling a playback state, such as a tempo change function for changing a playback speed of the video or a repeat playback function for repeating and playing back the video is used.
Patent Document 1: JP 2016-174637 A

However, in the above-described functions provided by the media player or the like, it is difficult for a user to customize a playback state of a video according to the use, such as for personal practice, and there is room for improvement.

### SUMMARY

According to an aspect of an embodiment, a video playback apparatus includes a processor configured to set a parameter related to a playback state of a first video, and control a playback state of a second video different from the first video in a display mode including a mode in which the first video and the second video are simultaneously displayed based on setting of the parameter, wherein playback timings of the first video and the second video are identified by time codes of the same music.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a video providing system;

FIG. 2 is a diagram illustrating an example of a flow of a dance lesson;

FIG. 3 is a diagram illustrating an example of a business model of a dance school;

FIG. 4 is a diagram illustrating one aspect of an approach for solving a problem;

FIG. 5 is a diagram illustrating one aspect of an approach for solving another problem;

FIG. 6 is a diagram illustrating an example of user story mapping;

FIG. 7 is a block diagram illustrating a functional configuration example of each device;

FIG. 8 is a schematic diagram illustrating an example of a recording method of a model video;

FIG. 9 is a diagram illustrating an example of a lesson selection screen;

FIG. 10 is a schematic diagram illustrating an example of a recording method of a student video;

FIG. 11 is a schematic diagram (1) illustrating a transition example of a playback control screen;

FIG. 12 is a schematic diagram (2) illustrating a transition example of a playback control screen;

FIG. 13 is a schematic diagram (3) illustrating a transition example of a playback control screen;

FIG. 14 is a schematic diagram illustrating an example of a display mode of a video;

FIG. 15 is a diagram illustrating an example of a model video;

FIG. 16 is a diagram illustrating an example of a student video;

FIG. 17 is a diagram illustrating an example of user setting of opacity;

FIG. 18 is a diagram illustrating an example of size change;

FIG. 19 is a diagram illustrating an example of a relationship between a dance practice procedure and functions;

FIG. 20 is a diagram illustrating a use case of checking a choreography timing;

FIG. 21 is a flowchart illustrating a recording processing procedure;

FIG. 22 is a sequence diagram illustrating a reservation processing procedure;

FIG. 23 is a flowchart illustrating a video playback processing procedure; and

FIG. 24 is a diagram illustrating a hardware configuration example.

### DESCRIPTION OF EMBODIMENTS

Hereinafter, modes for implementing a video playback apparatus and a video playback program according to the present disclosure (hereinafter, referred to as “embodiments”) will be described with reference to the accompanying drawings. Note that this embodiment merely illustrates one example or aspect, and the structure, action, function, property, characteristic, method, use, and the like according to the present disclosure are not limited by such an example.

### First Embodiment

### System Configuration

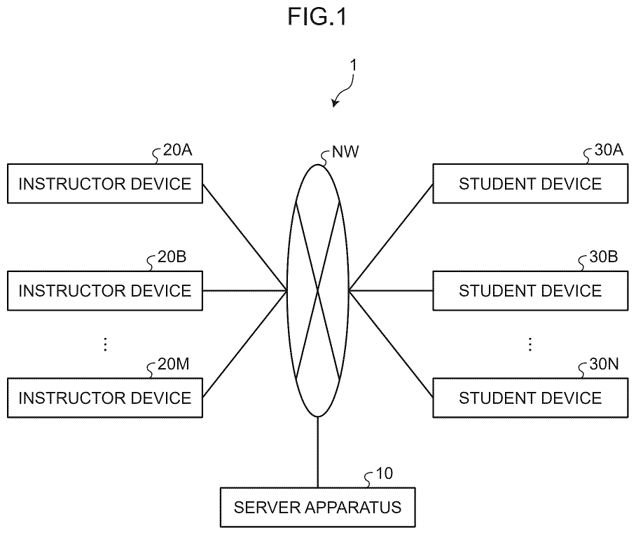

FIG. 1 is a diagram illustrating a configuration example of a video providing system. FIG. 1 illustrates a video providing system 1 that provides students with a model video having content to be taught by an instructor in a lesson before a start of the lesson. For example, in a case where the video providing system 1 is applied to a dance school, the video providing system 1 provides students with a model video in which the dance choreography to be taught by an instructor in a lesson is captured.

As illustrated in FIG. 1, the video providing system 1 may include a server apparatus 10, instructor devices 20A to 20M, and student devices 30A to 30N.

Hereinafter, in a case where it is not necessary to distinguish the individual instructor devices 20A to 20M, the instructor devices 20A to 20M may be referred to as “instructor devices 20”. Similarly, in a case where it is not necessary to distinguish the individual student devices 30A to 30N, the student devices 30A to 30N may be referred to as “student devices 30”.

The server apparatus 10, the instructor devices 20, and the student devices 30 may be communicably connected via an arbitrary network NW. Note that the network NW may be implemented by any type of communication network such as the Internet or a local area network (LAN) regardless of whether the network NW is wired or wireless.

The server apparatus 10 is an example of a computer that provides an information and communication technology (ICT) service related to a dance school. For example, the server apparatus 10 may be implemented by a supplier of the above-described ICT service, with a business operator that is a customer and provides a dance school, a dance studio, or other lessons as a service, and a student who is an end user and takes a lesson.

As an embodiment, the server apparatus 10 can provide the above-described video providing function as a cloud service by executing a platform as a service (PaaS) type middleware or a software as a service (SaaS) type application program. The server apparatus may be a cloud-based server.

Such an ICT service may be packaged with various functions such as, for a mere example, a reservation function for receiving lesson reservations and a video providing function for providing the model video before a start of a lesson.

The instructor device 20 is a terminal device used by an instructor belonging to a dance school or the like. Further, the student device 30 is a terminal device used by a student who participates in a lesson held by a dance school or the like. Note that the instructor device 20 and the student device 30 are an example of a video playback apparatus.

The instructor device 20 and the student device 30 may be implemented by any computer such as a personal computer or a smart device such as a smartphone, a tablet terminal, or a wearable terminal.

For example, a dancer application program that implements various functions such as a music editing function, a video playback function, and an image capturing function may be installed in the instructor device 20 and the student device 30. Hereinafter, a dancer application program may be referred to as a “dancer APP”.

As one aspect, the content to be taught by an instructor in a lesson, for example, a model video in which the dance choreography is captured may be uploaded from the instructor device 20 to the server apparatus 10. As another aspect, a model video uploaded from the instructor device 20 to the server apparatus 10 may be downloaded from the server apparatus 10 to the student device 30.

Hereinafter, an example in which the instructor device 20 and the student device 30 are implemented by a smart device such as a smartphone will be described as a mere example of a use case.

Note that, here, an example in which the above-described ICT service is provided as a cloud service has been described, but the present invention is not limited thereto. For example, the above-described ICT service may be provided on-premises.

### Pickup

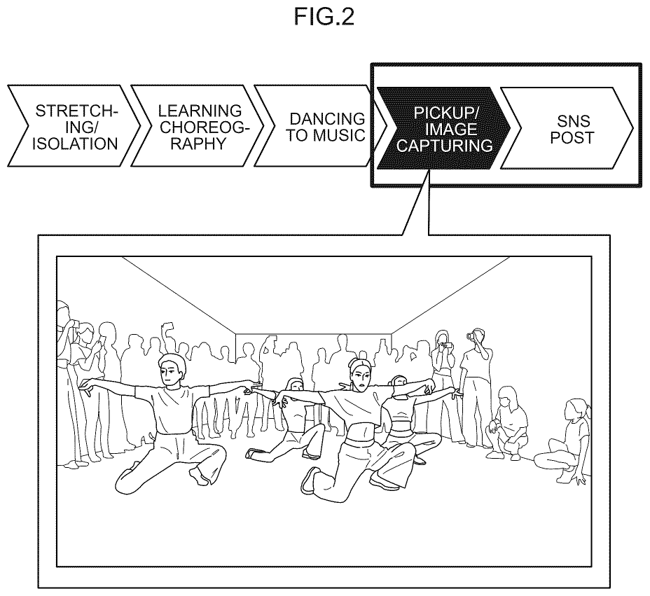

FIG. 2 is a diagram illustrating an example of a flow of a dance lesson. In FIG. 2, mere examples of menus for a lesson to be performed on the day are listed in time series. For example, in the example illustrated in FIG. 2, for the dance lesson, menus are listed in order of “stretching” and “isolation”, “learning choreography”, “dancing to music”, “image capturing for pickup”, and “SNS post”. Note that the SNS is an abbreviation of “social networking service”.

Among these menus, “pickup” means that a student selected by an instructor from among students taking the lesson at the end of the lesson dances in front of everyone together with the instructor. The dance performed by the picked-up student and the instructor in this manner may be posted on an SNS or the like after capturing.

As described above, the “pickup” is a simulated experience in which a student stands on the same stage with a teacher that the student admires and respects, and thus is one of motivations of the students who take the dance lesson.

### One Aspect of Problem

However, a student with a relatively high skill is usually selected for pickup, and a student with a relatively low skill is less likely to be selected for pickup. Even in a case where such a student is highly motivated to be selected for pickup, when the student continues not to be selected for pickup, the motivation to participate in the dance lesson also decreases.

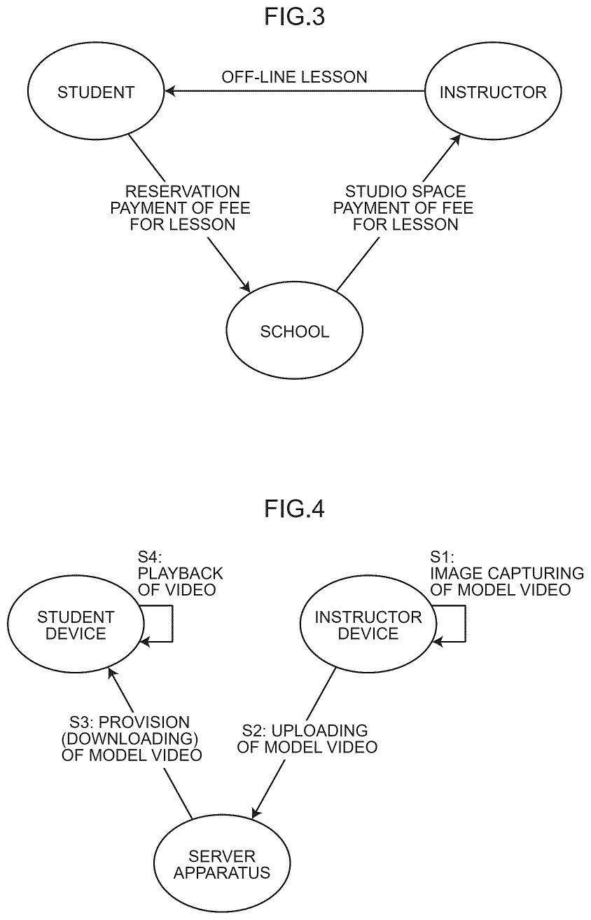

FIG. 3 is a diagram illustrating an example of a business model of a dance school. FIG. 3 illustrates an example of a business model performed by a dance school in the related art. As illustrated in FIG. 3, a business model of a dance school may include a dance school, an instructor, and a student as interested parties.

As one aspect, in activities from the student to the dance school, a reservation for a lesson held by the dance school and payment of a fee for the lesson taken by the student are performed. As another aspect, in activities from the dance school to the instructor, provision of a space in which the instructor provides an offline lesson to the student and payment for the lesson provided by the instructor to the student are performed. As described above, a business model has been constructed in which the instructor belonging to the dance school provides an offline lesson to the student enrolled by the dance school at a studio provided by the dance school.

In a case of such a business model, from the point of view of the student side, the following factors 1) to 4) are factors that decrease the students'motivations to participate in the dance lesson.
1) Since content of the lesson is not known in advance, the students cannot know whether or not the content is what the students want to take until the students actually take the lesson.
2) Even in a case where the content is what the students want to take, it is difficult to memorize the choreography during the lesson.
3) Since a student feels embarrassed when the teacher and other students see him/her not doing well, the student tends to sit at the back of the class.
4) As a result of the factors 1) to 3), the student is not selected for pickup.

Due to the factors 1) to 4), since the students cannot sufficiently enjoy the lesson, satisfaction levels of the students decrease, and an added value of the dance lesson also decreases.

### One Aspect of Approach for Solving Problem

Therefore, the video providing system 1 according to the present embodiment provides, before the start of the lesson, the student device 30 with a model video having content to be taught by the instructor in the lesson, for example, a model video in which the dance choreography is captured. Thereby, it is possible to implement preparation and advanced learning of the lesson content that has not yet been learned.

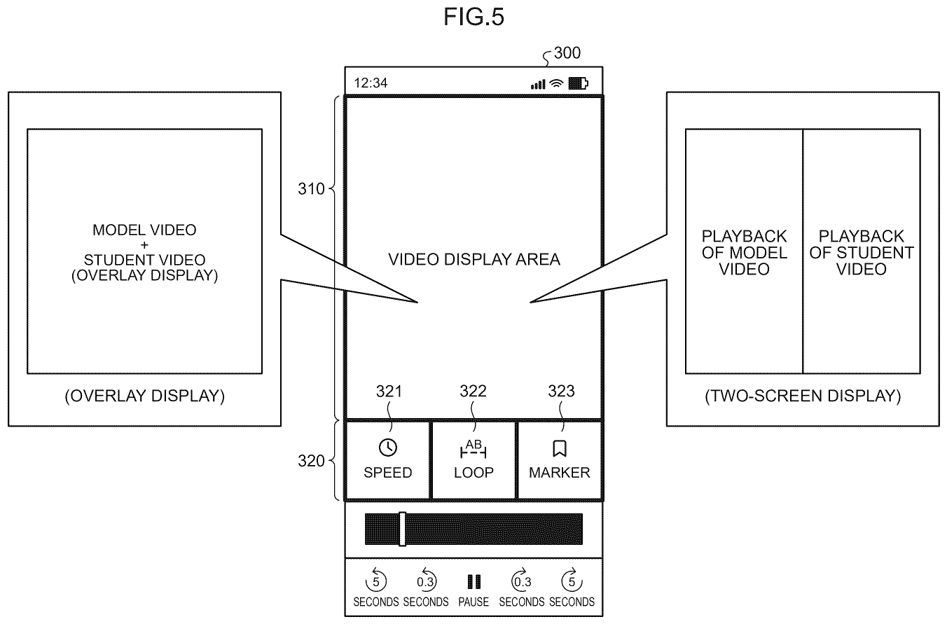

FIG. 4 is a diagram illustrating one aspect of an approach for solving the problems. As illustrated in FIG. 4, in the instructor device 20, the content to be taught by the instructor in the lesson, for example, the dance choreography is captured as a model video (step S1). The model video that is captured in this manner is uploaded from the instructor device 20 to the server apparatus 10 (step S2).

Further, the model video that is uploaded from the instructor device 20 to the server apparatus 10 is downloaded from the server apparatus 10 to the student device 30 before the start of the lesson (step S3). Then, the student device 30 plays back the model video that is downloaded from the server apparatus 10 (step S4).

In this way, by providing the model video before the start of the lesson, it is possible to perform preparation and advanced learning of the content of the lesson to be actually performed.

### One Aspect of Another Problem That Can Be Independent

Here, in a case where a student performs preparation by playing back a student video in which the student is captured, including the model video, in a technique in the related art, such as a media player, it is difficult for a user to customize a playback state of the video according to the use such as personal practice, and there is room for improvement.

For example, in an example of a dance, in a case where weakness parts in dance choreography are different for each user, the number and range of the weakness parts are also different. Further, the playback speed of the video to check the dance choreography is also different for each user. Even in a case where the student wants to customize setting of the playback function of the media player by adjusting the playback state of the video according to personal practice, the media player may lack the function and setting that the student wants for personal practice.

### One Aspect of Approach for Solving Another Problem That Can Be Independent

Therefore, the dancer APP according to the present embodiment has, as a part of the video playback function, a playback control function of controlling the playback state of the model video in a display mode in which the student video and the model video are simultaneously displayed, based on setting of parameters related to the playback state of the model video.

The “parameters related to the playback state” mentioned here may include, as a mere example, a playback speed, a playback position (playback timing), a loop, and other parameters defining the playback state.

FIG. 5 is a diagram illustrating one aspect of an approach for solving another problem. FIG. 5 illustrates a playback control screen 300 displayed on a display unit 32 of the student device 30, as a mere example of a user interface that provides the playback control function.

As illustrated in FIG. 5, the playback control screen 300 may include a video display area 310 in which a video to be played back is displayed, and a playback state setting area 320 that receives setting of parameters related to a playback state of a model video.

Among the areas, in the video display area 310, simultaneous playback of the student video and the model video can be performed. The “simultaneous playback” mentioned here may include “overlay display” in which two videos of the student video and the model video are superimposed and displayed, and “two-screen display” in which two videos of the student video and the model video are displayed side by side. By using the display modes such as “overlay display” and “two-screen display”, it is possible to perform comparison between two videos of the student video and the model video.

The playback state setting area 320 may include, as a mere example, a tempo change tab 321 for changing the playback speed of the video, a loop setting tab 322 for receiving designation of a loop in the playback time of the video, and a marker setting tab 323 for receiving designation of a playback position of the video.

By using the tempo change tab 321, the loop setting tab 322, and the marker setting tab 323, it is possible to perform calling of the playback speed change function, the loop function, and the marker function.

For example, even in a case where the number and range of weakness parts in dance choreography are different for each user, each of the weakness parts can be played back from the beginning by calling the marker function, or the range of each of the weakness parts can be repeatedly played back by calling the loop function. In addition, even in a case where the playback speed of the video to check the dance choreography is different for each user, it is possible to play back the video at the playback speed at which the user can check the weakness part by calling the playback speed change function.

Therefore, according to the video playback function, it is possible to implement video playback by easily customizing the playback state of the video. Thereby, it is possible to enhance efficiency of learning such as advanced learning, preparation, and the like by using the video playback function for preparation and advanced learning of the content of the lesson to be actually performed.

As a mere example, it is possible to support a user who voluntarily practices content of a lesson before taking a lesson by using the video playback function. Thereby, for example, in a case of a dance lesson, it is possible to provide an opportunity to increase a possibility that the user is selected for pickup of the dance lesson.

For example, as illustrated in FIG. 4, it is possible to overcome the factor that decreases the motivation in the factors 1) to 4) illustrated in FIG. 3.
1A) By sharing the content of the lesson in advance, the student can take the content that he/she wants to take when he/she wants to take the content.
2A) It is possible to perform preparation to a certain level by using the video playback function, and the student can repeatedly practice the weakness part at a his/her pace.
3A) Since preparation can be performed as individual practice, so-called voluntary practice, the student can perform preparation without hesitating to make a mistake in choreography or the like and without losing his/her enthusiasm. As a result, the student will participate in the lesson with confidence without worrying about human eyes. Thereby, the possibility that the student is selected for pickup is increased.
4A) The dance skill is improved in a fun way, and thus, the student wants to continue the dance lesson.

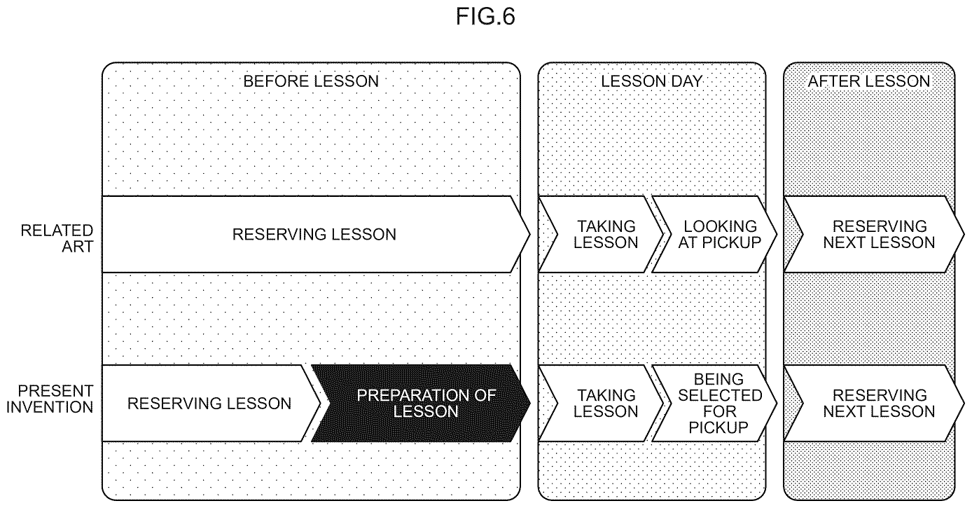

According to the effects 1A) to 4A), the satisfaction level of the student is enhanced, and the added value of the dance lesson is also improved. Thus, user story mapping illustrated in FIG. 6 is implemented.

FIG. 6 is a diagram illustrating an example of user story mapping. As illustrated in FIG. 6, in the related art, a student with a relatively low skill is likely to fall into a cycle of reserving a lesson, taking a lesson, looking at pickup, and reserving a next lesson. As such a cycle is repeated, only a student with a relatively high skill continues to be selected for pickup, and other students'expectations of being selected for pickup continue to be undermined. As a result, the student who is not easily selected for pickup continues to lose motivation to participate in the dance lesson.

On the other hand, according to the video providing function according to the present embodiment, the student can increase the possibility of being selected for pickup by reserving a lesson, performing preparation of the lesson, and then taking the lesson. Thus, it is possible to create a cycle in which the student reserves the next lesson in a state where the motivation to participate in the dance lesson is high. Thereby, it is possible to increase the expectations that not only a student with a relatively high skill but also all students participating in the lesson will be selected for pickup. As a result, the motivation to participate in the dance lesson can also be improved.

Note that, in this example, a case where the two functions of the video providing function and the video playback function are used in combination has been exemplified, but only one of the video providing function and the video playback function may be provided. For example, the video playback function can also be applied to use cases other than advanced learning and preparation of a lesson. That is, the model video does not necessarily need to be a video in which the dance choreography by an instructor of a lesson school is captured, and it goes without saying that the video playback function can be used to play back any model video published on the Internet.

Further, in this example, a dance video in which the dance choreography is captured has been exemplified as a mere example of the model video and the student video, but the present invention is not limited thereto. For example, in addition to the dance video, a motion in baseball, golf, and other sports may be captured as a model video and a student video.

### Configuration of Each Device

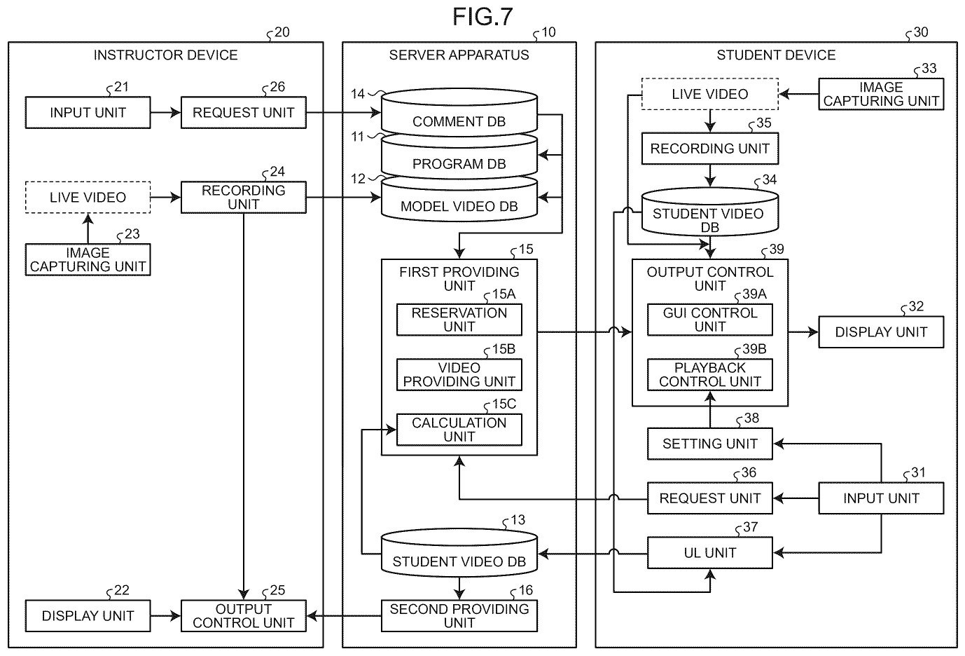

Next, a configuration of each device included in the video providing system 1 according to the present embodiment will be described. FIG. 7 is a block diagram illustrating a functional configuration example of each device. FIG. 7 schematically illustrates blocks related to the functions of the server apparatus 10, the instructor device 20, and the student device 30. Note that FIG. 7 merely illustrates extracted functional units related to the ICT service and the video playback function, and functional units other than the units illustrated in FIG. 7 may be provided in each device.

### Configuration of Instructor Device

First, a functional configuration example of the instructor device 20 according to the present embodiment will be described. As illustrated in FIG. 7, the instructor device 20 includes an input unit 21, a display unit 22, an image capturing unit 23, a recording unit 24, an output control unit 25, and a request unit 26. Note that, as a matter of course, functional units other than the functional units illustrated in FIG. 7, for example, a communication control unit that provides a communication interface, a storage unit that is implemented by a storage, and the like may also be included.

The input unit 21 has a function of receiving various instruction inputs. For example, the input unit 21 may be implemented by an operating system (OS) or an application program that operates on the instructor device 20, for example, a graphical user interface (GUI) provided by the dancer APP.

The display unit 22 has a function of displaying various types of information. As one aspect, the display unit 22 may be implemented by a liquid crystal display, an organic electro luminescence (EL) display, or the like.

The input unit 21 and the display unit 22 can be integrated as a display input unit implemented by a touch panel or the like.

The image capturing unit 23 has an image capturing function of capturing an image. The “image” mentioned here may be either a still image or a video. For example, in a case where the instructor device 20 is implemented by a smart device, the image capturing unit 23 can be implemented by a camera unit such as a front camera arranged in the same direction as a front surface of a screen of the display unit 22 or a rear camera arranged on a back surface of a screen of the display unit 22.

The recording unit 24 has a recording function of recording the image captured by the image capturing unit 23. As one aspect, the recording unit 24 can record the content to be taught by the instructor in the lesson, for example, a model video in which the dance choreography is captured.

Such a recording function may be implemented as one of modules packaged in the dancer APP as a mere example. For example, the recording function is activated by receiving an operation of a video recording button that receives a recording request from a main menu screen provided by the dancer APP.

In a case where the recording function is activated in this manner, transition is performed from the main menu screen to a music selection screen for selecting music to be embedded in the model video. For example, the music selection screen may include, as a music option, a music file downloaded and purchased with an account of an instructor. In addition, a music file provided by a streaming service subscribed with an account of an instructor, a music file generated from a project file edited by the music editing function, and the like may be included. Then, in a case where music to be embedded in the model video is selected on the music selection screen via the input unit 21, transition is performed from the music selection screen to a recording screen.

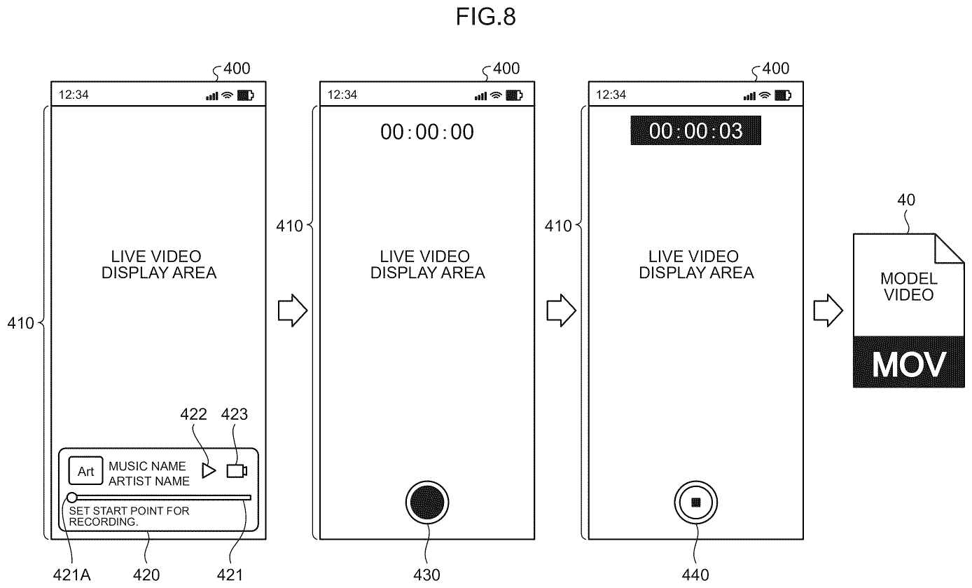

FIG. 8 is a schematic diagram illustrating an example of a recording method of a model video. FIG. 8 schematically illustrates a state where a recording screen 400 displayed on the display unit 22 of the instructor device 20 transitions from left to right according to an operation procedure. As illustrated in FIG. 8, the recording screen 400 may include a live video display area 410 and a setting window 420.

Among the areas, a live video that is captured in real time by the image capturing unit 23 is displayed in the live video display area 410. The setting window 420 is a window that receives setting of a playback timing at which recording is started in a playback time of music to be embedded in a model video. For example, the setting window 420 may be displayed by being superimposed on a front surface of the live video display area 410.

The setting window 420 may include a slider bar (seek bar) 421, a slider 421A, a playback button 422, and a recording button 423. For example, the slider bar 421 corresponds to a range of the playback time of the music selected on the music selection screen, and the slider 421A indicates the playback position, that is, the playback timing. The slider 421A can be moved by a drag operation or can be moved by playing back music by a pressing operation of the playback button 422.

In a case where the slider 421A is set to a position corresponding to the playback timing at which the start of recording is desired and then the recording button 423 is pressed, a recording start button 430 is displayed on the recording screen 400. Note that the display of the recording start button 430 may be linked with non-display of the setting window 420.

Here, in a case where the recording start button 430 is operated, recording of the live video that is captured in real time by the image capturing unit 23 is started. At this time, the recording of the live video can be started after the countdown display is performed for a predetermined time, for example, three seconds or five seconds. In a case where recording is started in this manner, the recording start button 430 is switched to a recording stop button 440.

Then, until the recording is ended by the end of the playback time of the music, or until the recording is ended by stopping the recording by the recording stop button 440, the recording unit 24 continues the following recording processing. For example, the recording unit 24 sets a time code (HH:MM:SS:FF) of the playback timing of the music being played back, in a video of an n-th frame captured by the image capturing unit 23. Then, the recording unit 24 records the video in which the time code is set. Thereby, the time code of the music is embedded in each frame of the video included in the model video.

Thereafter, in a case where the recording is ended by the end of the playback of the music or in a case where the recording is ended by stopping the recording by the recording stop button 440, the recording unit 24 stores, as a model video 40, a video captured in a section from a playback timing corresponding to the start of the recording to a playback timing corresponding to the playback end of the music or the recording stop, in a storage or the like (not illustrated).

The model video recorded in this manner may be uploaded from the instructor device 20 to the server apparatus 10. At this time, the model video uploaded to the server apparatus 10 is registered in a model video DB 12 by being associated with identification information of an instructor who is a creator and identification information of the lesson.

The output control unit 25 has a function of controlling an output related to various types of information. The “output” mentioned here may include a display output and a sound output. As one aspect, the output control unit 25 can cause the display unit 22 to display a student video viewing screen including a GUI component that receives an instruction input for requesting viewing of the student video uploaded from the student device 30 to the server apparatus 10 and an input of a comment on the student video. For example, the viewing of the student video may be implemented by causing the server apparatus 10 to access a link in which the student video and the media player for playing back the student video are embedded. In addition, the viewing of the student video may be implemented by playing back the student video downloaded from the server apparatus 10 by the video playback function of the dancer APP. Further, the input of the comment on the student video may be implemented by a GUI element such as a text box.

The request unit 26 has a function of transmitting a request to the server apparatus 10. As one aspect, in a case where an input of a comment on the student video is received via the student video viewing screen, the request unit 26 can request the server apparatus 10 to register the received input of the comment. The comment that is requested to be registered in this way from the instructor device 20 to the server apparatus 10 is registered in a comment DB 14 to be described later in a state of being associated with the identification information of the instructor as a reply source and the identification information of the student as a reply destination.

### Configuration of Server Apparatus

Next, a functional configuration example of the server apparatus 10 according to the present embodiment will be described. As illustrated in FIG. 7, the server apparatus 10 includes a program database (DB) 11, a model video DB 12, a student video DB 13, a comment DB 14, a first providing unit 15, and a second providing unit 16. Note that, as a matter of course, functional units other than the functional units illustrated in FIG. 7, for example, a communication control unit that provides a communication interface, a storage unit that is implemented by a storage, and the like may also be included.

The program DB 11 is a database that stores a lesson program. The “lesson program” mentioned here is a program in which schedules of a plurality of lessons are defined. As one aspect, the program DB 11 may be data in which pieces of identification information of lessons opened in each time zone are associated with each time zone.

The model video DB 12 is a database that stores a set of model videos. As one aspect, meta information such as identification information of an instructor who is a creator or identification information of a lesson may be associated with the model video stored in the model video DB 12.

The student video DB 13 is a database that stores a set of student videos. As one aspect, the student video stored in the student video DB 13 may be associated with meta information such as account information of a student who is a creator, identification information of a lesson in which the student participates, and identification information of an instructor in charge of the lesson.

The comment DB 14 is a database that stores a set of comments. As one aspect, the comment stored in the comment DB 14 may be associated with meta information such as identification information of an instructor as a reply source and identification information of a student as a reply destination.

The first providing unit 15 has a function of providing an ICT service for the student device 30. As illustrated in FIG. 7, the first providing unit 15 includes a reservation unit 15A, a video providing unit 15B, and a calculation unit 15C.

The reservation unit 15A has a reservation function of receiving a reservation of a lesson. As one aspect, in a case where a request for browsing a lesson program is received from the student device 30, the reservation unit 15A reads, from the program DB 11, a lesson program corresponding to the date and time or the time zone designated by the request. Then, the reservation unit 15A provides the student device 30 with a lesson selection screen that receives an instruction input for requesting viewing of a model video for each lesson included in the lesson program and an instruction input of a lesson for requesting taking a lesson.

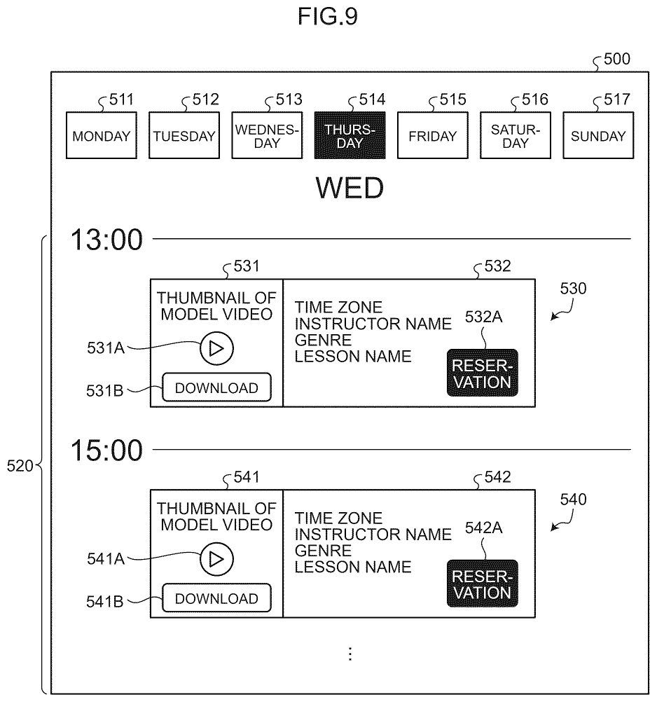

FIG. 9 is a diagram illustrating an example of a lesson selection screen 500. As illustrated in FIG. 9, the lesson selection screen includes day selection buttons 511 to 517 and a lesson display field 520. These day selection buttons 511 to 517 correspond to the respective days of the week from Monday to Sunday. Here, as a mere example, an example in which the days of the week are displayed has been described, but other calendar information such as the date may be displayed together with the days of the week. In the lesson display field 520, lessons are arranged, the lessons being held on the day of the week corresponding to the day selection button being selected among the day selection buttons 511 to 517. For example, in the example illustrated in FIG. 9, in the lesson display field 520, among the lessons held on Wednesday corresponding to the day selection button 514, lesson information 530 held from 13:00 and lesson information 540 held from 15:00 are extracted and displayed.

Among these pieces of information, the lesson information 530 includes a display area 531 for the model video and a display area 532 for detailed information of the lesson. Further, the display area 531 for the model video includes a playback button 531A and a download button 531B. The playback and the download of the model video by using operations of the playback button 531A and the download button 531B may be restricted or prohibited before a reservation of the lesson. For example, the playback and the download of the model video may be entirely prohibited until the lesson is reserved, or the playback may be permitted only in some sections of the model video. In a case where designation of the section in which the playback is permitted in this way can be received from the instructor device 20, in the music to be played back in the model video, a section belonging to a specific development, for example, a section belonging to a hook-line may be automatically set. On the other hand, the example in which the playback and the download of the model video are restricted or prohibited before the reservation of the lesson has been described as a mere example, and the playback and the download of all sections of the model video may be permitted before the reservation of the lesson.

After the reservation of the lesson, in a case where an operation of the playback button 531A is received, the model video can be played back by the media player incorporated in the lesson information 530. Further, in a case where an operation of the download button 531B is received, the model video is provided to the student device 30 by the video providing unit 15B to be described later. Thereby, the model video is downloaded to the student device 30, and as a result, the video playback function can be used.

Further, in the display area 532 for detailed information of the lesson, detailed information such as a time zone in which the lesson is held, an instructor name in charge of the lesson, a genre of the lesson, and a lesson name is displayed, and a reservation reception button 532A for receiving the reservation of the lesson is arranged. For example, in a case where an operation of the reservation reception button 532A is received, the reservation unit 15A registers account information assigned to the student who is the user of the student device 30, for example, identification information of the student, in a participation frame of the lesson. Note that, for the lesson information 540, there is no difference in function although the targeted lesson is different.

The video providing unit 15B has a function of providing a model video. As a mere example, in a case where a request for requesting download of the model video, for example, an operation of the download button included in the lesson selection screen 500 illustrated in FIG. 9 is received, the video providing unit 15B provides the student device 30 with the model video of the lesson designated by the request among the model videos stored in the model video DB 12.

The calculation unit 15C has a function of calculating a dance evaluation index between the model video and the student video. As an example of such an evaluation index, a dance synchronization rate is used as an example. A higher synchronization rate indicates that the motion of the instructor in the model video matches the motion of the student in the student video. The “motion” mentioned here may refer to, as an example, a time-series change in posture corresponding to the dance choreography or the like. As one aspect, in a case where a request for calculating a synchronization rate is received from the student device 30, the calculation unit 15C reads the model video of the lesson that is designated by the request from among the model videos stored in the model video DB 12, and reads the student video of the lesson that is designated by the request from among the student videos stored in the student video DB 13. Then, the calculation unit 15C calculates a synchronization rate of the dance of the student video with respect to the model video. For example, the synchronization rate may be calculated from a matching degree of an angle of a specific joint, for example, an angle of an arm, an elbow, a wrist, a foot, a knee, an ankle, or the like by comparing a frame of the model video and a frame of the student video. For calculation of such a synchronization rate, it is possible to use a framework of a machine learning model that implements detection of a position of a bounding box of an object in an image and object detection for executing classification of the object for each frame of the model video and each frame of the student video, skeleton detection for detecting a position of each joint from an image of a bounding box corresponding to the object labeled as a “person” as a result of the classification, scoring for calculating a synchronization rate from a matching degree of an angle of a joint, and the like. The synchronization rate that is calculated in this manner is output to the student device 30 as a response.

The second providing unit 16 has a function of providing an ICT service for the instructor device 20. As one aspect, in a case where the student video is uploaded from the student device 30, the second providing unit 16 provides a student video viewing screen including a GUI component that receives an instruction input for requesting viewing of the student video and an input of a comment on the student video, to the instructor device 20 used by an instructor in charge of the lesson corresponding to the student video.

### Configuration of Student Device

Next, a functional configuration example of the student device 30 according to the present embodiment will be described. As illustrated in FIG. 7, the student device 30 includes an input unit 31, a display unit 32, an image capturing unit 33, a student video DB 34, a recording unit 35, a request unit 36, an upload (UL) unit 37, a setting unit 38, and an output control unit 39. Note that, as a matter of course, functional units other than the functional units illustrated in FIG. 7, for example, a communication control unit that provides a communication interface, a storage unit that is implemented by a storage, and the like may also be included.

The input unit 31 has a function of receiving various instruction inputs. For example, the input unit 31 may be implemented by an OS or an application program that operates on the student device 30, for example, a GUI provided by the dancer APP.

The display unit 32 has a function of displaying various types of information. As one aspect, the display unit 32 may be implemented by a liquid crystal display, an organic EL display, or the like.

The input unit 31 and the display unit 32 can be integrated as a display input unit implemented by a touch panel or the like.

The image capturing unit 33 has an image capturing function of capturing an image. The “image” mentioned here may be either a still image or a video. For example, in a case where the student device 30 is implemented by a smart device, the image capturing unit 33 can be implemented by a camera unit such as a front camera arranged in the same direction as a front surface of a screen of the display unit 32 or a rear camera arranged on a back surface of a screen of the display unit 32.

The student video DB 34 is a database that stores a set of student videos. As one aspect, the student video stored in the student video DB 34 may be associated with meta information such as account information of a student who is a creator, identification information of a lesson in which the student participates, and identification information of an instructor in charge of the lesson.

The recording unit 35 has a recording function of recording the image captured by the image capturing unit 33. As one aspect, the recording unit 35 can record the student video in which the dance performed by the student is captured in a state where the video is played back using the video player function.

Such a video player function may be implemented as one of modules packaged in the dancer APP as a mere example. For example, the video player function is activated by receiving an operation of a video player button for playing back a video from a main menu screen provided by the dancer APP.

In a case where the video player function is activated in this manner, transition is performed from the main menu screen to a video selection screen for selecting a video to be played back. For example, a list of videos may be displayed on the video selection screen, and a model video may be included as an option in the list of videos. Then, in a case where the model video is selected on the video selection screen via the input unit 31, transition is performed from the video selection screen to the recording screen. Note that only the music of the model video may be played back when recording the student video by performing transition from the main menu screen to a music selection screen for selecting music to be embedded as a background music (BGM) of the student video.

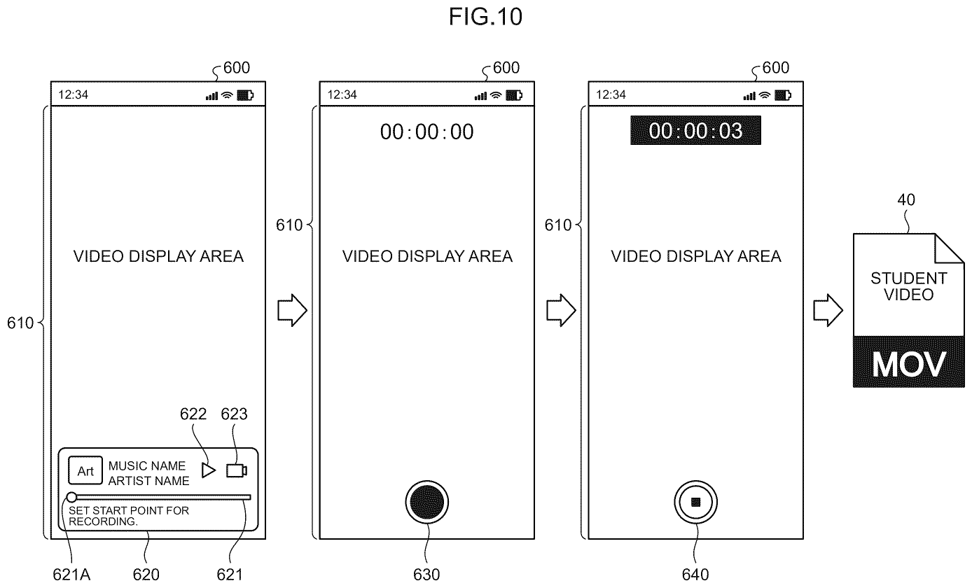

FIG. 10 is a schematic diagram illustrating an example of a recording method of a student video. FIG. 10 schematically illustrates a state where a recording screen 600 displayed on the display unit 32 of the student device 30 transitions from left to right according to an operation procedure. As illustrated in FIG. 10, the recording screen 600 may include a video display area 610 and a setting window 620.

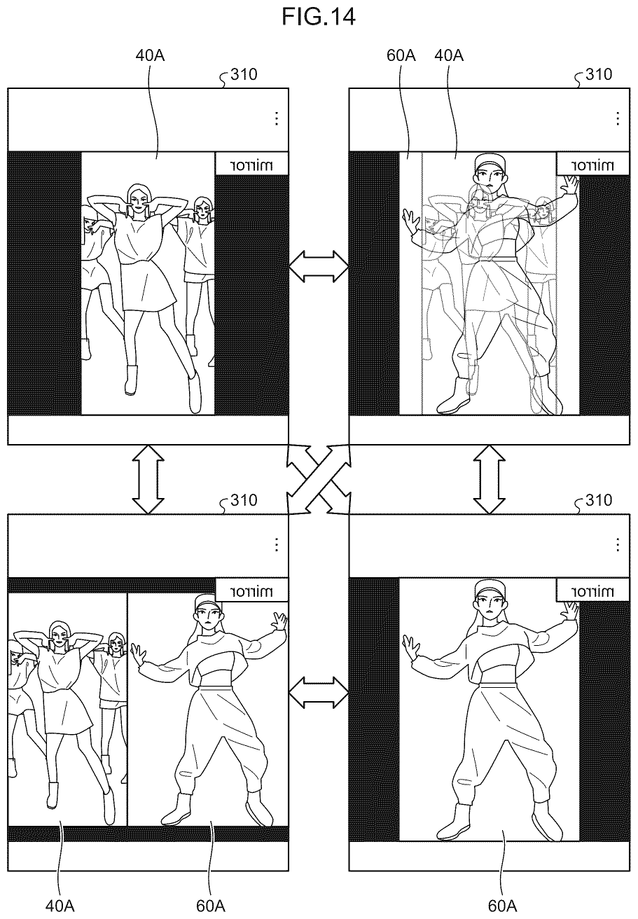

Among the areas, a live video that is captured in real time by the image capturing unit 33 is displayed in the video display area 610. Although details will be described later with reference to FIG. 14, in the video display area 610, display of a live video or a model video or simultaneous display of a live video and a model video may be executed in an arbitrary display mode among a first mode to a fourth mode to be described later. The setting window 620 is a window that receives setting of a playback timing at which recording is started in a playback time of the model video. For example, the setting window 620 may be displayed by being superimposed on a front surface of the video display area 610.

The setting window 620 may include a slider bar (seek bar) 621, a slider 621A, a playback button 622, and a recording button 623. For example, the slider bar 621 corresponds to a range of the playback time of the model video selected on the video selection screen, and the slider 621A indicates the playback position, that is, the playback timing. The slider 621A can be moved by a drag operation or can be moved by playing back the model video by a pressing operation of the playback button 622.

In a case where the slider 621A is set to a position corresponding to the playback timing at which the start of recording is desired and then the recording button 623 is pressed, a recording start button 630 is displayed on the recording screen 600. Note that the display of the recording start button 630 may be linked with non-display of the setting window 620.

Here, in a case where the recording start button 630 is operated, recording of the live video that is captured in real time by the image capturing unit 33 is started. At this time, the recording of the live video can be started after the countdown display is performed for a predetermined time, for example, three seconds or five seconds. In a case where recording is started in this manner, the recording start button 630 is switched to a recording stop button 640.

Then, until the recording is ended by the end of the playback time of the model video, or until the recording is ended by stopping the recording by the recording stop button 640, the recording unit 35 continues the following recording processing. For example, the recording unit 35 sets a time code (HH:MM:SS:FF) of the playback timing of the model video being played back, in a video of an n-th frame captured by the image capturing unit 33. Then, the recording unit 35 records the video in which the time code is set. Thereby, the time code of the model video and the time code of the music embedded in the model video are embedded in each frame of the video included in the student video. Therefore, the playback timings of the model video and the student video can be identified by the time code of the same music, and the model video and the student video can be simultaneously played back. Thus, the model video and the student video can be synchronized with each other by the time code.

Thereafter, in a case where the recording is ended by the end of the playback of the model video or in a case where the recording is ended by stopping the recording by the recording stop button 640, the recording unit 35 stores the student video 60 that is captured in a section from a playback timing corresponding to the start of the recording to a playback timing corresponding to the playback end of the music or the recording stop, in the student video DB 34. At this time, the student video may be associated with meta information such as account information of the student who is the creator, identification information of the lesson corresponding to the model video played back by the video player function when the student video is recorded, and identification information of the instructor in charge of the lesson.

Note that, here, an example has been described in which the instructor device 20 has a video recording function of recording a live video captured by the image capturing unit 23 while playing back music and the student device 30 has a function of recording a live video captured by the image capturing unit 33 while playing back a video such as a model video by the video player function. On the other hand, the present invention is not limited thereto. For example, the instructor device 20 may have a function of recording a live video captured by the image capturing unit 33 while playing back a video by the video player function, or the student device 30 may have the video recording function.

The request unit 36 has a function of transmitting a request to the server apparatus 10. As one aspect, in a case where a synchronization-rate browsing instruction is received via the input unit 31, the request unit 36 transmits, to the server apparatus 10, a synchronization-rate browsing request including the identification information of the student video and the identification information of the model video, the identification information being designated by the browsing instruction. As a response to such a browsing request, a calculation result of the synchronization rate by the calculation unit 15C of the server apparatus 10 may be displayed on the display unit 32.

The UL unit 37 has a function of uploading data to the server apparatus 10. As one aspect, in a case where an instruction to upload the student video to the server apparatus 10 is received via the input unit 31, the UL unit 37 uploads the meta information to the server apparatus 10 together with the student video. Such meta information may include identification information of the student video, identification information of the lesson corresponding to the model video played back by the video player function when the student video is recorded, identification information of the instructor in charge of the lesson, and the like. The student video that is uploaded in this manner is stored in the student video DB 13.

The setting unit 38 has a function of setting parameters related to a playback state of a video. As one aspect, in a case where a parameter related to the playback state of the model video is designated via the playback control screen 300, the setting unit 38 sets the parameter in a playback control unit 39B to be described later.

The output control unit 39 has a function of controlling an output related to various types of information. The “output” mentioned here may include a display output and a sound output. As illustrated in FIG. 7, the output control unit 39 includes a GUI control unit 39A and a playback control unit 39B.

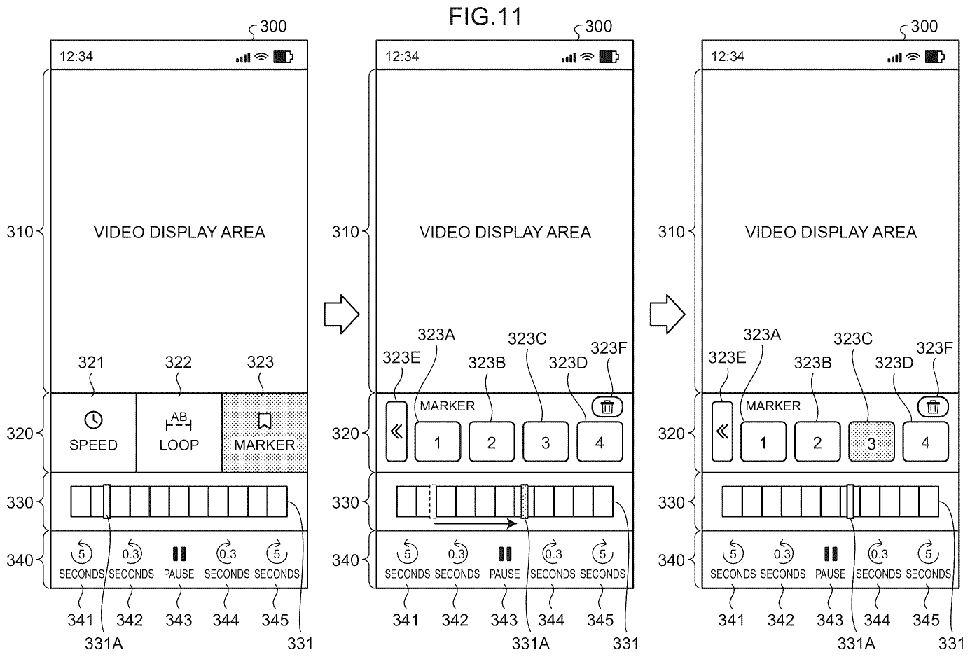

The GUI control unit 39A has a function of executing display control of a GUI screen displayed on the display unit 32. As one aspect, in a case where a playback instruction of the model video, a playback instruction of the student video, or a playback instruction of the model video and the student video is received via the input unit 31, the GUI control unit 39A displays the playback control screen 300 illustrated in FIG. 11 on the display unit 32.

FIG. 11 is a schematic diagram (1) illustrating a transition example of the playback control screen 300. FIG. 11 schematically illustrates a state where the playback control screen 300 displayed on the display unit 32 of the student device 30 transitions from left to right according to an operation procedure. As illustrated in FIG. 11, the playback control screen 300 may include a thumbnail bar display area 330 and a controller display area 340, in addition to the video display area 310 and the playback state setting area 320 described above with reference to FIG. 3.

In the thumbnail bar display area 330, as a preview of the model video, a thumbnail bar 331 in which thumbnail images of the model video are arranged in order of playback timing in a horizontal direction, for example, a right-left direction or a row direction is displayed. By sliding a slider 331A on such a thumbnail bar 331, the student can designate a playback position of the model video while visually recognizing the playback content of the model video corresponding to the playback position.

The controller display area 340 may include a first rewinding button 341, a second rewinding button 342, a playback/pause button 343, a second fast-forwarding button 344, and a first fast-forwarding button 345.

Both the first rewinding button 341 and the second rewinding button 342 are buttons for rewinding the playback position of the video, but the rewinding periods are different from each other. For example, in the example illustrated in FIG. 11, the rewinding period by one tap of the first rewinding button 341 is set to five seconds, and the rewinding period by one tap of the second rewinding button 342 is set to 0.3 seconds. When the first rewinding button 341 is tapped, rewinding of the playback position for five seconds is performed. On the other hand, when the second rewinding button 342 is tapped, rewinding of the playback position for 0.3 seconds is performed. The rewinding periods of the first rewinding button 341 and the second rewinding button 342 are merely an example, and user setting of an arbitrary period can be executed.

The playback/pause button 343 is a button for instructing playback or pause of a video. For example, during a period for which a video is being played back, the playback/pause button 343 is displayed as an icon corresponding to pause. On the other hand, during a period for which a video is being stopped, the playback/pause button 343 is displayed as an icon corresponding to playback.

Both the second fast-forwarding button 344 and the first fast-forwarding button 345 are buttons for fast-forwarding the playback position of the video, but the fast-forwarding periods are different from each other. For example, in the example illustrated in FIG. 11, the fast-forwarding period by one tap of the first fast-forwarding button 345 is set to five seconds, and the fast-forwarding period by one tap of the second fast-forwarding button 344 is set to 0.3 seconds. When the first fast-forwarding button 345 is tapped, fast-forwarding of the playback position for five seconds is performed. On the other hand, when the second fast-forwarding button 344 is tapped, fast-forwarding of the playback position for 0.3 seconds is performed. The fast-forwarding periods of the first fast-forwarding button 345 and the second fast-forwarding button 344 are merely an example, and user setting of an arbitrary period can be executed.

The reason why the GUI components for rewinding and fast-forwarding are divided into two types and arranged in this way is that the use desired by the user is also divided into two types. That is, in a case where it is desired to perform rough rewinding or rough fast-forwarding, for example, in a case where it is desired to call a specific scene around the playback position during playback, the first rewinding button 341 and the first fast-forwarding button 345 are used. On the other hand, in a case where it is desired to perform fine rewinding or fine fast-forwarding, for example, in a case where it is desired to observe the dance in a detailed manner by frame feeding during a period for which the video is being stopped, the second rewinding button 342 and the second fast-forwarding button 344 are used.

As one aspect, on the playback control screen 300, the marker function can be called through an operation on the marker setting tab 323. For example, in a case where the marker setting tab 323 is tapped, the display of the playback state setting area 320 transitions from the tab display of the tempo change tab 321, the loop setting tab 322, and the marker setting tab 323 to the button display for marker setting. That is, in the playback state setting area 320, marker buttons 323A to 323D, a return button 323E, and a trash box button 323F are displayed.

Each of the marker buttons 321A to 321D is a button for instructing playback from the playback position where the marker is set. Here, as a mere example, FIG. 11 illustrates an example in which a marker is set for the marker button 321C under a situation where markers are not set for all the marker buttons 321A to 321D. For example, by moving the slider 331A in a right-left direction on the thumbnail bar 331, a playback position at which the user wants to set a marker is designated. Then, in a case where the playback position is designated and then the marker button 321C is tapped, the marker of the marker button 321C is set at the playback position corresponding to the position of the slider 331A. As described above, from the viewpoint of distinguishing the marker button 321C for which the marker is already set from the marker buttons 321A, 321B, and 321D for which the marker is not set, display of the marker button 321C is changed to a display form different from the display forms of the marker buttons 321A, 321B, and 321D, for example, a different display color (hatching display in FIG. 11).

Note that the return button 321E is a button for returning the display of the playback state setting area 320 to the tab display of the tempo change tab 321, the loop setting tab 322, and the marker setting tab 323. In addition, the trash box button 321F is a button for deleting setting of the marker. For example, in a case where the trash box button 321F is tapped and then the marker button for which the marker is already set is tapped, the marker that is set for the marker button is deleted.

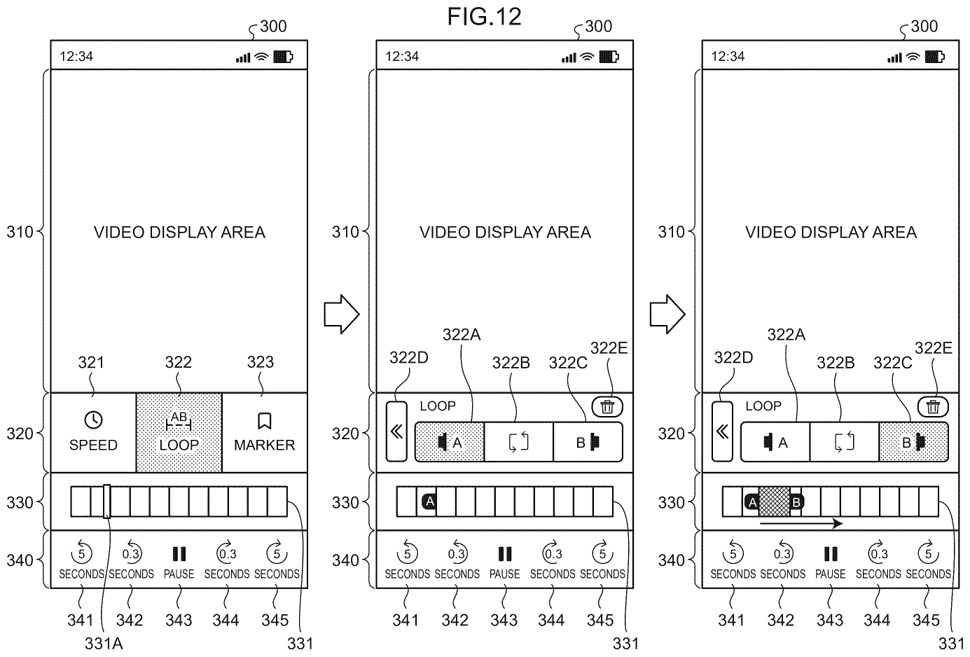

As another aspect, on the playback control screen 300, the loop function can be called through an operation on the loop setting tab 322. FIG. 12 is a schematic diagram (2) illustrating a transition example of the playback control screen 300. FIG. 12 also schematically illustrates a state where the playback control screen 300 displayed on the display unit 32 of the student device 30 transitions from left to right according to an operation procedure.

As illustrated in FIG. 12, in a case where the loop setting tab 322 is tapped, the display of the playback state setting area 320 transitions from the tab display of the tempo change tab 321, the loop setting tab 322, and the marker setting tab 323 to the button display for loop setting. That is, in the playback state setting area 320, a start position designation button 322A, a loop switch 322B, an end position designation button 322C, a return button 322D, and a trash box button 322E are displayed.

The start position designation button 322A is a button for designating a playback position at which loop playback is started. The end position designation button 322C is a button for designating a playback position at which loop playback is ended. The loop switch 322B is a button for switching ON/OFF of loop playback.

For example, by moving the slider 331A in a right-left direction on the thumbnail bar 331, the playback position at which the user wants to set the start or end of the loop playback is designated. In the example illustrated in FIG. 12, in a case where the start position designation button 322A is tapped, a start position pointer of the loop playback is set at the playback position designated on the thumbnail bar 331, that is, at the position of the mark “A”. Further, in a case where the end position designation button 322C is tapped, an end position pointer of the loop playback is set at the playback position designated on the thumbnail bar 331, that is, at the position of the mark “B”. In a case where the start position pointer and the end position pointer are set and then the loop switch 322B is tapped, loop playback is set to an ON state. In this case, loop playback in a section between the start position pointer and the end position pointer, that is, a hatched section on the thumbnail bar 331 illustrated in FIG. 12 is started. As described above, from the viewpoint of notifying that the loop playback is switched to the ON state, in a case where the loop playback is in the ON state, the loop switch 322B can be displayed in a highlighted manner.

Note that the return button 322D is a button for returning the display of the playback state setting area 320 to the tab display of the tempo change tab 321, the loop setting tab 322, and the marker setting tab 323. Further, the trash box button 322E is a button for deleting setting of loop playback. For example, in a case where the trash box button 322E is tapped and then the loop switch 322B for which the loop playback is already set is tapped, the loop playback that is set for the loop switch 322B is deleted.

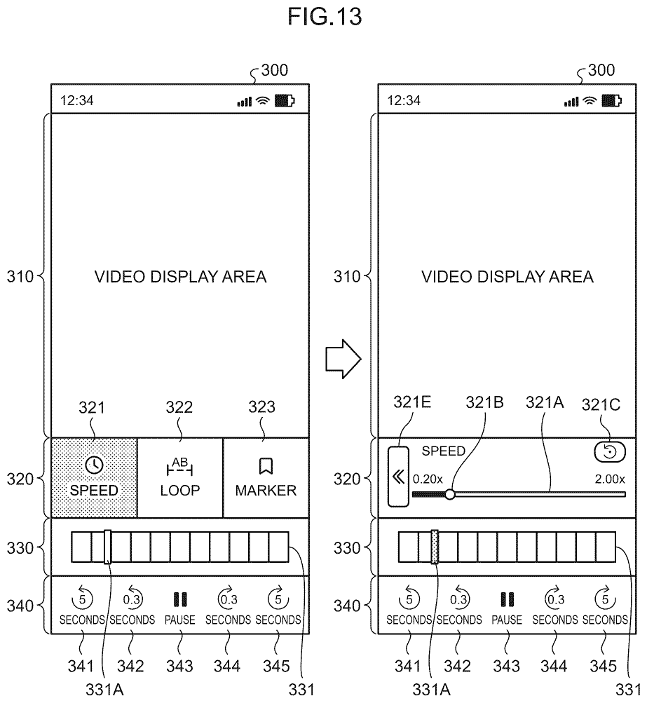

As another aspect, on the playback control screen 300, the tempo change function can be called through an operation on the tempo change tab 321. FIG. 13 is a schematic diagram (3) illustrating a transition example of the playback control screen 300. FIG. 13 also schematically illustrates a state where the playback control screen 300 displayed on the display unit 32 of the student device 30 transitions from left to right according to an operation procedure.

As illustrated in FIG. 13, in a case where the tempo change tab 321 is tapped, the display of the playback state setting area 320 transitions from the tab display of the tempo change tab 321, the loop setting tab 322, and the marker setting tab 323 to the display of the GUI component for changing the tempo. That is, in the playback state setting area 320, a slider bar 321A, a slider 321B, an initialization button 321C, and a return button 321E are displayed.

For example, by moving the slider 331A in a right-left direction on the slider bar 321A corresponding to a range from a minimum of 0.20 times to a maximum of 2.00 times, the speed at which the user desires to play back the video is designated. Further, in a case where the initialization button 321C is tapped, the playback speed is initialized to 1.00 times. In addition, in a case where the return button 322D is tapped, the display of the playback state setting area 320 is returned to the tab display of the tempo change tab 321, the loop setting tab 322, and the marker setting tab 323. Note that, here, although an example in which the magnification of the playback speed is designated has been described, the playback speed may be designated by beats per minute (BPM).

As a further aspect, on the playback control screen 300, a video can be displayed in the video display area 310 by switching a plurality of display modes. As a mere example of such a display mode, a first mode for displaying the model video, a second mode for displaying the model video and the student video in an overlaid manner, a third mode for displaying the model video and the student video side by side, and a fourth mode for displaying the student video may be included.

FIG. 14 is a schematic diagram illustrating an example of a display mode of a video. FIG. 14 illustrates display examples of videos respectively corresponding to the first mode, the second mode, the third mode, and the fourth mode in order of the upper left, the upper right, the lower left, and the lower right.

In the first mode to the fourth mode, it is possible to freely switch the display mode from an arbitrary mode to an arbitrary mode. Here, in all the modes, an example in which the original video is played back in a state of being reversed in the horizontal direction, for example, the right-left direction is illustrated.

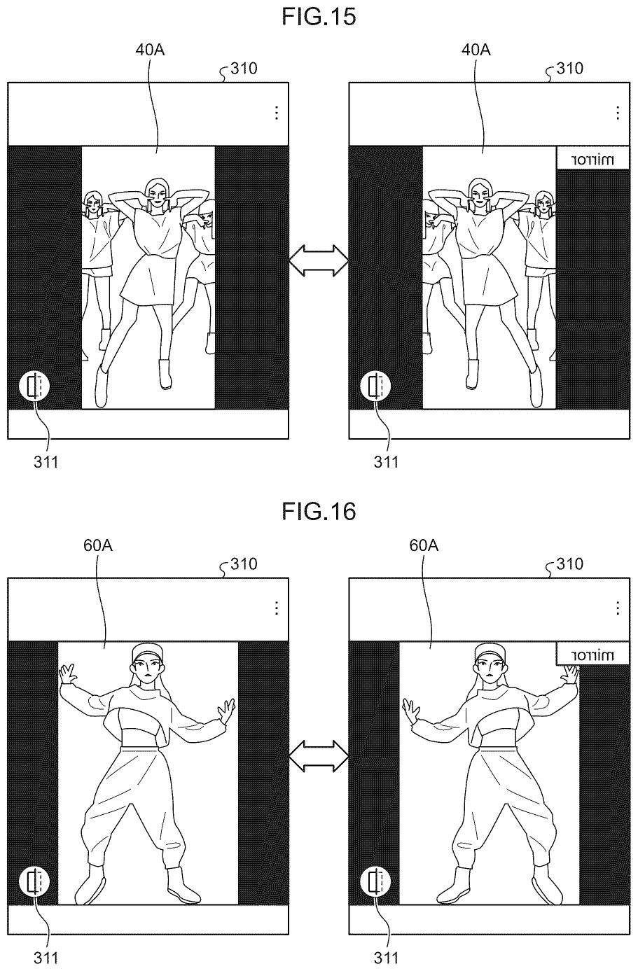

FIG. 15 is a diagram illustrating an example of a model video. FIG. 16 is a diagram illustrating an example of a student video. Hereinafter, in a case where a video in which the horizontal direction is reversed is being played back in the video display area 310, from the viewpoint of clearly indicating that the horizontal direction is being reversed, a mirror character of “mirror” is displayed at an upper right position of the video display area 310. As illustrated in FIG. 15 and FIG. 16, in a case where a flip button 311 is tapped, the model video 40 and the student video 60 displayed in the video display area 310 are symmetrically reversed in the right-left direction. Hereinafter, from the viewpoint of distinguishing labels between the original model video and the model video in which the right-left direction is reversed, the model video in which the right-left direction is reversed may be referred to as an “reversed model video”. For the same purpose, the student video in which the right-left direction is reversed may be referred to as a “reversed student video”. Thereby, the reversed model video 40A or the reversed student video 60A is displayed in the video display area 310. In this way, an advantage of reversing the original model video and the original student video is that, even in a case where the student remembers the dance choreography in the same way as the student look, it is possible to prevent the choreography from becoming a mirror image in which the right-left direction is reversed. Note that, in a case where the flip button 311 is tapped again, the reversed model video 40A and the reversed student video 60A are returned to the original model video 40 and the original student video 60. In this way, by an operation on the flip button 311, the display of the original model video 40 and the original student video 60 and the display of the reversed model video 40A and the reversed student video 60A can be freely switched.

Returning to the description of FIG. 14, in the first mode, only the reversed model video 40A is displayed in the video display area 310. In the second mode, overlay display is performed, the overlay display being a form for displaying the reversed model video 40A and the reversed student video 60A in the video display area 310 in a state where the reversed model video 40A is superimposed on a front surface of the reversed student video 60A. In the third mode, two-screen display is performed, the two-screen display being a form for displaying two videos of the reversed model video 40A and the reversed student video 60A in the video display area 310 side by side in the horizontal direction or the vertical direction. In the fourth mode, only the reversed student video 60A is displayed in the video display area 310. Note that, here, an example in which two videos of the reversed model video 40A and the reversed student video 60A are displayed side by side in the horizontal direction or the vertical direction has been described, but the arrangement of the two videos is not limited thereto. For example, the reversed model video 40A and the reversed student video 60A may be displayed side by side in an oblique direction.

Here, in the second mode, as a mere example, the reversed model video 40A is displayed in a state where opacity is set to 50% by default, but the opacity of the reversed model video 40A may be set by the user.

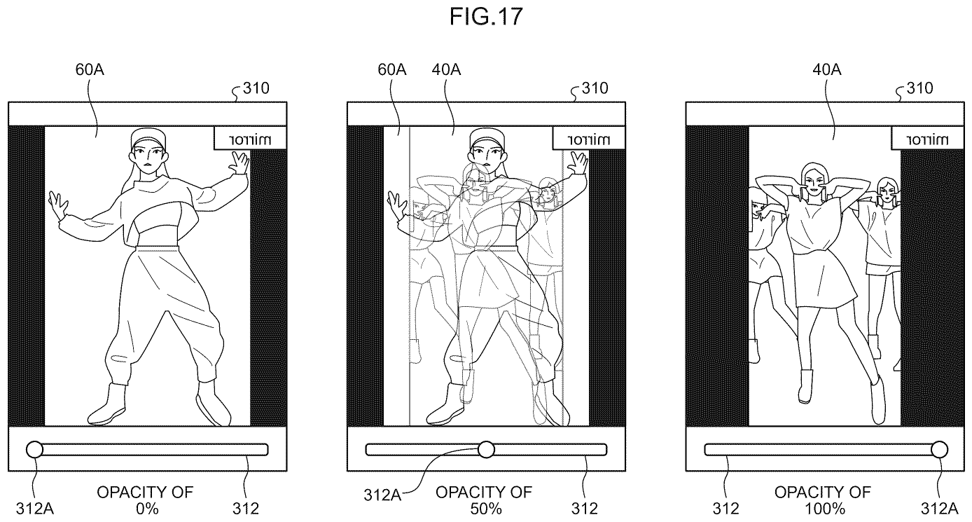

FIG. 17 is a diagram illustrating an example of user setting of opacity. FIG. 17 illustrates three examples of a case where the opacity of the reversed model video 40A is set to 0%, a case where the opacity of the reversed model video 40A is set to 50%, and a case where the opacity of the reversed model video 40A is set to 100%. As illustrated in FIG. 17, in the video display area 310, a slider bar 312 for setting the opacity of the reversed model video 40A may be provided. In the slider bar 312, a numerical range of the opacity from a minimum of 0% to a maximum of 100% is assigned. By moving a slider 312A to an arbitrary position on the slider bar 312, the user can set the opacity to an arbitrary value. For example, in a case where the opacity of the reversed model video 40A is set to 0%, only the reversed student video 60A is displayed in the video display area 310. On the other hand, in a case where the opacity of the reversed model video 40A is set to 100%, only the reversed model video 40A is displayed in the video display area 310. Not only the minimum opacity and the maximum opacity, but also arbitrary opacity can be set by the user. Thereby, it is possible to implement overlay display that matches with recognition characteristics of the student.

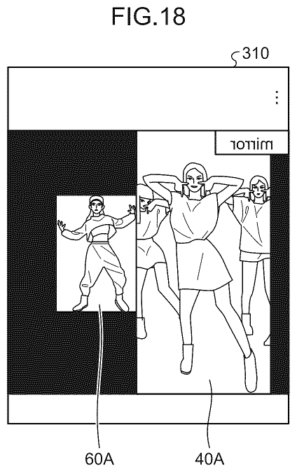

Further, in each mode of the first mode to the fourth mode, positions and sizes of the reversed model video 40A and the reversed student video 60A can be changed. FIG. 18 is a diagram illustrating an example of size change. FIG. 18 illustrates an example in which, in the reversed model video 40A and the reversed student video 60A displayed in the third mode illustrated in FIG. 14, the position of the reversed student video 60A is moved in a right direction and the size of the reversed student video 60A is reduced. In this way, the position and the size can be arbitrarily changed by user setting. For example, the display size can be reduced in a case where a pinch-in operation on the reversed model video 40A or the reversed student video 60A is received, or the display size can be enlarged in a case where a pinch-out operation on the reversed model video 40A or the reversed student video 60A is received. Further, the display position of the reversed model video 40A or the reversed student video 60A can be moved in a case where a drag operation on the reversed model video 40A or the reversed student video 60A is received, and movement of the display position can be ended by a drop operation. Note that, although FIG. 18 illustrates an example in which the position and the size are changed, the reversed model video 40A and the reversed student video 60A can also be rotated.

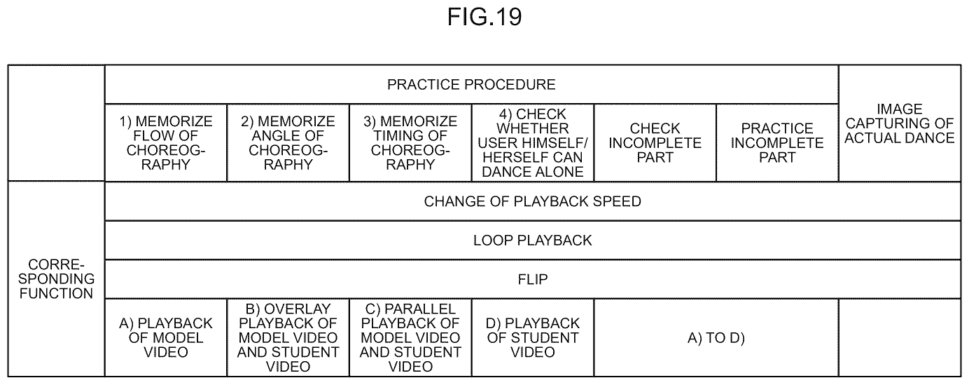

By freely switching the first mode to the fourth mode, the student can customize the playback state of the video according to the use when learning the dance choreography. FIG. 19 is a diagram illustrating an example of a relationship between a dance practice procedure and the functions. As illustrated in FIG. 19, the change of the playback speed, the loop playback, and the flip (reverse) of the video can be effectively used in all the steps of practicing the dance choreography. Further, 1) in a stage of memorizing a flow of choreography, the effectiveness of the first mode, that is, “playback of model video” is high. Further, 2) in a stage of memorizing an angle of choreography, the effectiveness of the second mode, that is, “overlay playback” is high. Further, 3) in a stage of memorizing a timing of choreography, the effectiveness of the third mode, that is, “parallel playback” is high. Further, 4) in a stage of checking whether or not the user himself/herself can dance, the effectiveness of the fourth mode, that is, “playback of student video” is high.

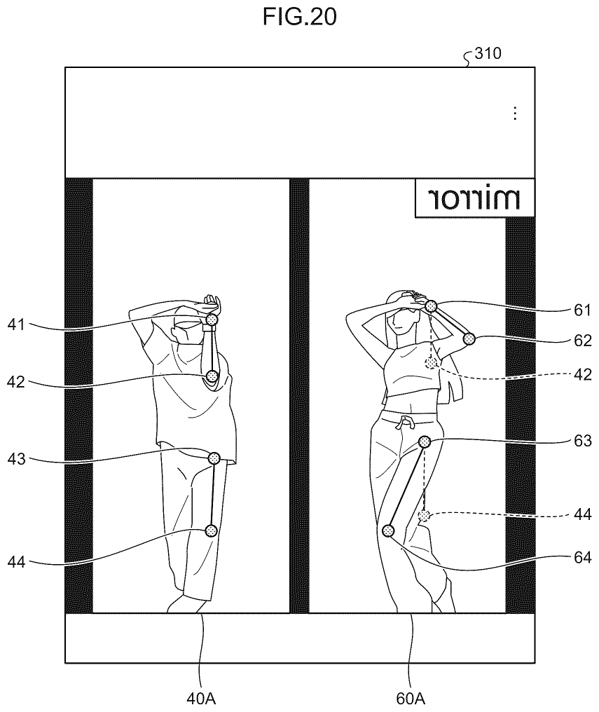

FIG. 20 is a diagram illustrating a use case of checking a choreography timing. FIG. 20 illustrates an example in which the reversed model video 40A and the reversed student video 60A are displayed in the video display area 310 side by side. For example, in the example illustrated in FIG. 20, it is possible to check that there is a deviation in pose between the instructor and the student by comparing the reversed model video 40A and the reversed student video 60A. That is, there is a deviation between directions of the right wrist 41 and the right elbow 42 of the instructor and directions of the right wrist 61 and the right elbow 62 of the student, and there is also a deviation between directions of the right waist 43 and the right knee 44 of the instructor and directions of the right waist 63 and the right knee 64 of the student. Such a deviation in pose may be output as a calculation result of the synchronization rate by the calculation unit 15C. The student who has checked the deviation in pose can determine that the deviation in pose is caused by a fact that the choreography timing of the student is deviated by one tempo from the choreography timing of the instructor.

Returning to the description of FIG. 7, the playback control unit 39B has a function of executing playback control of the video displayed in the video display area 310. As one aspect, the playback control unit 39B plays back the video corresponding to the display mode of the video display area 310 according to setting of the parameters related to the playback state that is set by the setting unit 38, for example, setting of the magnification of the playback speed, setting of the loop playback section, and setting of the marker. At this time, in a case where the second mode or the third mode is selected as the display mode of the video display area 310, the playback control unit 39B plays back the model video and the student video according to the time code of the model video. Note that, in a case where the second mode or the third mode is selected, the same parameter is used to play back the model video and the student video.

### Flow of Processing

Next, a flow of processing of the video providing system according to the present embodiment will be described. Here, (1) recording processing executed by the instructor device 20, (2) reservation processing executed by the server apparatus 10 and the student device 30, and (3) video playback processing executed by the student device 30 will be described in this order.

### (1) Recording Processing

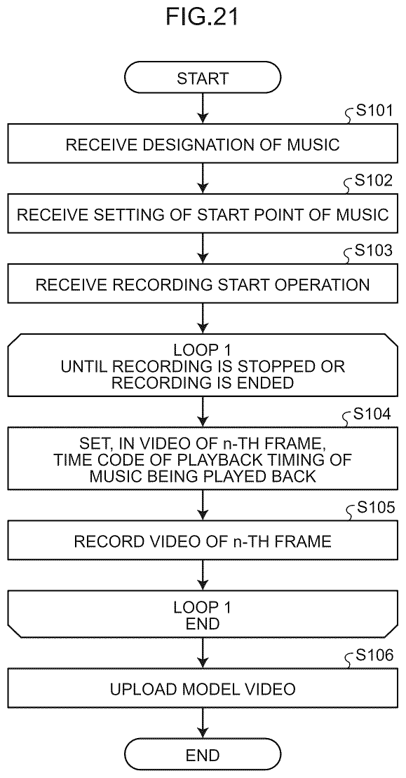

FIG. 21 is a flowchart illustrating a recording processing procedure. As a mere example, this processing can be started in a case where an operation of a video recording button is received, the video recording button being a button that receives a recording request from a main menu screen provided by the dancer APP.

As illustrated in FIG. 21, the recording unit 24 receives designation of music to be embedded in the model video captured by the instructor from now on (step S101). Subsequently, the recording unit 24 receives the setting of the playback timing at which recording is started in the playback time of the music of which the designation is received in step S101 (step S102). Then, the recording unit 24 receives a recording start operation (step S103).

Thereafter, the recording unit 24 executes loop processing 1 that repeats processing of the following step S104 and processing of the following step S105 until the recording is ended by the end of the playback time of the music of which the designation is received in step S101 or the recording is ended by a stop of the recording.

That is, the recording unit 24 sets a time code (HH:MM:SS:FF) of the playback timing of the music being played back, in a video of an n-th frame captured by the image capturing unit 23 (step S104). Then, the recording unit 24 records the video in which the time code is set in step S104 (step S105).

By repeating such loop processing 1, the model video in which the time code of the music designated by the instructor is embedded in each frame of the video captured by the image capturing unit 23 is recorded.

Thereafter, the recording unit 24 uploads a video file of the model video recorded by the repetition of the loop processing 1 to the server apparatus 10 (step S106), and ends the processing.

In this way, the model video uploaded to the server apparatus 10 in step S106 is stored in the model video DB 12 of the server apparatus 10. Note that, as a matter of course, the model video may also be stored in a storage or the like included in the instructor device 20.

### (2) Reservation Processing

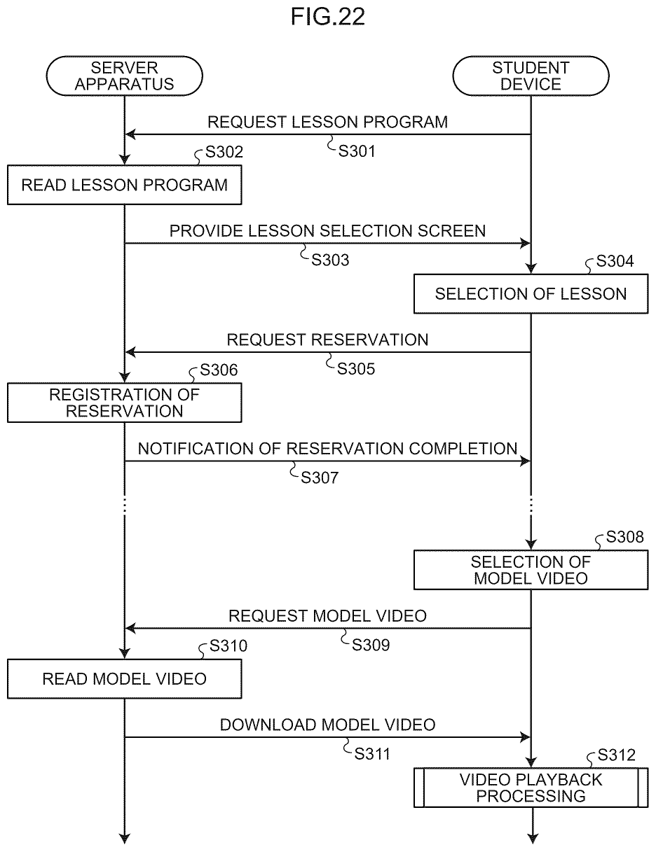

FIG. 22 is a sequence diagram illustrating a reservation processing procedure. As illustrated in FIG. 22, the reservation unit 15A of the server apparatus 10 receives a request for browsing a lesson program from the student device 30 (step S301). Subsequently, the reservation unit 15A of the server apparatus 10 reads a lesson program corresponding to the date and time or the time zone designated by the request from the program DB 11 (step S302).

Then, the reservation unit 15A of the server apparatus 10 provides the student device 30 with a lesson selection screen that receives an instruction input for requesting viewing of a model video for each lesson included in the lesson program and an instruction input of a lesson for requesting taking a lesson (step S303).

On the other hand, in a case where a reservation reception button is selected (step S304), the reservation reception button being assigned to one lesson among the lessons included in the lesson selection screen, the request unit 36 of the student device 30 transmits, to the server apparatus 10, a request for requesting reservation registration of the lesson to which the reservation reception button is assigned (step S305).

Then, the reservation unit 15A registers account information assigned to the student who is the user of the student device 30, for example, identification information of the student, in a participation frame of the lesson (step S306), and notifies the student device 30 of completion of the reservation (step S307).

When reception of the reservation of the lesson is completed in this way, the student device 30 is permitted to release functions such as playback and download of the model video.

After completion of the reservation reception, the student device 30 receives an operation of the playback button of the model video from among the lessons included in the lesson selection screen provided in step S303 (step S308). Then, the request unit of the student device 30 transmits, to the server apparatus 10, a request for requesting download of the model video for which the operation of the playback button is received (step S309).

When download of the model video is requested in this way, the video providing unit 15B of the server apparatus 10 reads the model video corresponding to the lesson designated by the request from among the model videos stored in the model video DB 12, and provides the read model video to the student device 30 (step S310 and step S311).

Then, the playback control unit 39B of the student device 30 executes video playback processing using the model video provided in step S307 (step S312), and ends the processing.

The processing from step S308 to step S312 can be repeated any number of times until the display on the display unit 32 of the student device 30 transitions from the lesson selection screen to another screen. Note that the model video downloaded in step S311 can be played back using the dancer APP even after the display transitions from the lesson selection screen to another screen.

### (3) Video Playback Processing

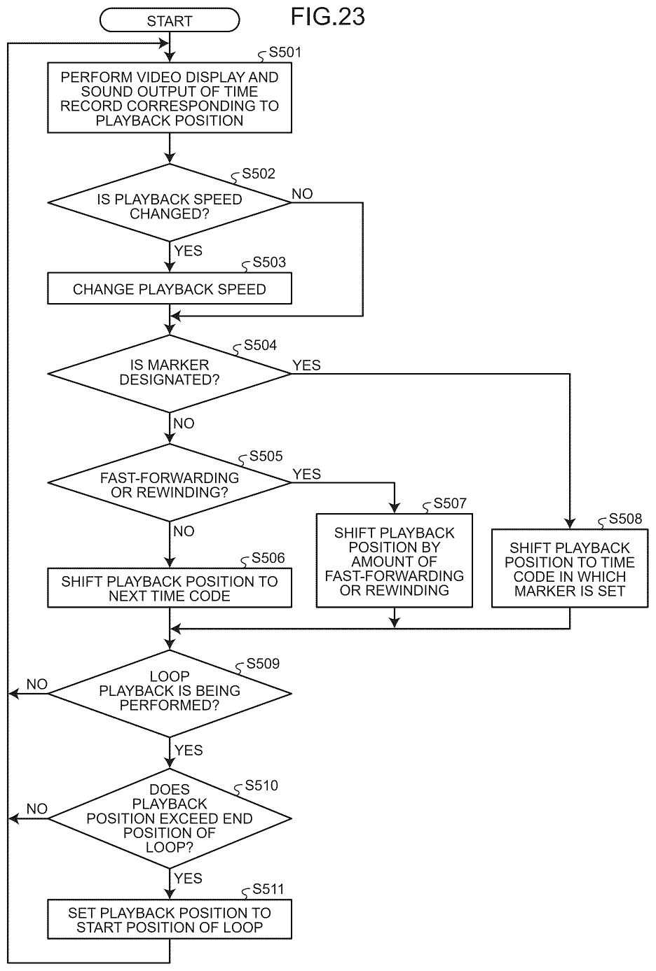

FIG. 23 is a flowchart illustrating a video playback processing procedure. This processing may be continuously executed even in a case where the video is being played back. Note that each step described in this flowchart can be applied even in a case where the display mode of the video display area 310 is any mode of the first mode to the fourth mode.

As illustrated in FIG. 23, the playback control unit 39B causes the display unit to display, in the video display area 310, the video of the frame in which the time code corresponding to the playback position is set, and causes the sound output unit (not illustrated) to output a sound of the frame in which the time code is set (step S501).

Subsequently, in a case where the playback speed is changed via the tempo change tab 321 (step S502: Yes), the setting unit 38 changes the parameter related to the playback speed by the playback control unit 39B to the playback speed corresponding to the position of a slider 323B on a slider bar 323A (step S503).

In a case where the marker is designated via the marker setting tab 323 (step S504: Yes), the playback control unit 39B shifts the playback position to the time code in which the marker is set (step S508).

In a case where a fast-forwarding operation or a rewinding operation is performed (step S504: No and step S505: Yes), the playback control unit 39B executes fast-forwarding or rewinding for a fast-forwarding period or a rewinding period (step S507).

In a case where neither a marker is designated nor a fast-forwarding operation or a rewinding operation is performed (step S504: No and step S505: No), the playback control unit 39B shifts the time code to the next time code by adding a time width corresponding to the frame rate to the time code corresponding to the playback position (step S506).

Thereafter, in a case where the loop playback is in an ON state (step S509: Yes), the playback control unit 39B determines whether or not the playback position exceeds an end position of a section in which the loop is set (step S510).

At this time, in a case where the playback position exceeds the end position of the section in which the loop is set (step S510: Yes), the playback control unit 39B sets the playback position as a start position of the loop setting (step S511), and returns to the processing of step S501.

In a case where the loop playback is in an OFF state (step S509: No) or in a case where the playback position does not exceed the end position of the section in which the loop is set (step S510: No), the processing proceeds to the processing of step S501 without executing the processing of step S511.

### SUMMARY

As described above, the video providing system 1 according to the present embodiment provides, before the start of the lesson, the student device 30 with a model video having content to be taught by the instructor in the lesson, for example, a model video in which the dance choreography is captured. Therefore, according to the video providing system 1 according to the present embodiment, it is possible to support the user who voluntarily practices the lesson content before taking the lesson.

Further, the student device 30 according to the present embodiment controls the playback state of the model video in the display mode in which the student video and the model video are simultaneously displayed, based on setting of parameters related to the playback state of the model video. Therefore, according to the student device 30 according to the present embodiment, it is possible to implement video playback by easily customizing the playback state of the video.

### Exhibition of Creativity

The matters described in the embodiment, for example, the number of the instructor devices 20 and the student devices 30, specific examples of various screens, and the like are merely examples, and can be changed. Further, in the flowchart described in the embodiment, the order of processing can also be changed within a range without contradiction.

### System

The processing procedure, the control procedure, the specific name, and the information including various data and parameters described in the specification and the drawings can be arbitrarily changed unless otherwise specified. For example, one or more functional units of the first providing unit 15 and the second providing unit 16 included in the server apparatus 10 may be configured as separate devices.

In addition, each component of each device illustrated in the drawings is functionally conceptual, and is not necessarily physically configured as illustrated in the drawings. That is, specific forms of distribution and integration of the devices are not limited to the forms illustrated in the drawings. That is, all or some of the components can be functionally or physically distributed and integrated in an arbitrary unit according to various loads, usage conditions, and the like. Note that each component may be a physical component.

Further, all or some of the processing functions performed in the devices can be implemented by a central processing unit (CPU) and a program to be analyzed and executed by the CPU, or can be implemented as hardware by wired logic.

### Hardware

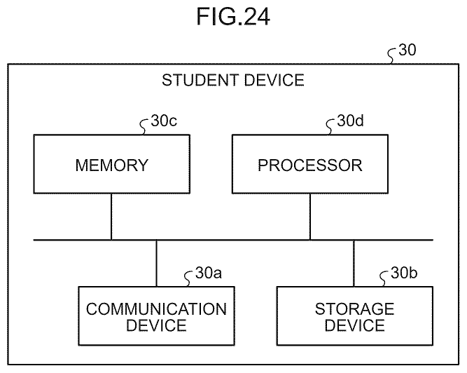

Next, a hardware configuration example of the computer described in the embodiment will be described. FIG. 24 is a diagram illustrating a hardware configuration example. As illustrated in FIG. 24, the student device 30 includes a communication device 30a, a storage device 30b, a memory 30c, and a processor 30d. Note that the units illustrated in FIG. 24 may be connected to each other by a bus or the like. Note that, although FIG. 24 illustrates the hardware configuration example of the student device 30, the server apparatus 10 and the instructor device 20 may also be implemented by a similar hardware configuration.

The communication device 30a is a network interface card or the like. The storage device 30b is a storage device such as a hard disk drive (HDD) or a solid state drive (SSD). For example, the storage device 30b stores a program for operating the functions illustrated in FIG. 7, a DB, and the like.

The processor 30d reads a program for executing processing similar to the processing of the processing unit illustrated in FIG. 7 from the storage device 30b or the like, and develops the program in the memory 30c. Thereby, a process for executing the functions described in FIG. 7 is operated.

Such a process implements functions similar to the functions of the processing unit included in the student device 30. For example, the processor 30d reads a program having functions similar to the functions of the recording unit 35, the request unit 36, the UL unit 37, the setting unit 38, the output control unit 39, and the like, from the storage device 30b or the like. Then, the processor 30d executes a process of executing processing similar to the processing in the recording unit 35, the request unit 36, the UL unit 37, the setting unit 38, the output control unit 39, and the like.

In this way, the student device 30 operates as an information processing device that executes the video playback method by reading and executing the program. In addition, the student device 30 can implement functions similar to the functions in the embodiment by reading the program from a recording medium by a medium reading device and executing the read program.

Note that the program mentioned in the embodiment is not limited to as being executed by the student device 30. For example, the present invention can be similarly applied to a case where another computer or another server executes a program or a case where these computers execute a program in cooperation. As a mere example, the video playback function may be provided by executing the program by the instructor device 20. As another example, in a case where the program is executed by the server apparatus 10, a video providing service corresponding to the video playback function may be provided from the server apparatus 10 to the instructor device 20 and the student device 30.

The program can be distributed via a network such as the Internet. In addition, the program can be executed by being recorded in an arbitrary recording medium and being read from the recording medium by a computer. For example, the recording medium can be implemented by a hard disk, a flexible disk (FD), a CD-ROM, a magneto-optical disk (MO), a digital versatile disc (DVD), or the like.

According to an embodiment, video playback can be implemented by easily customizing a playback state of a video.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A video playback apparatus comprising:
a processor configured to:
set a parameter related to a playback state of a first video; and
control a playback state of a second video different from the first video in a display mode including a mode in which the first video and the second video are simultaneously displayed based on setting of the parameter,
wherein playback timings of the first video and the second video are identified by time codes of the same music.

2. The video playback apparatus according to claim 1, wherein the second video is recorded.

3. The video playback apparatus according to claim 1, wherein the second video is a live video that is captured in real time.

4. The video playback apparatus according to claim 1, wherein the first video or the second video is displayed in a horizontally reversed state.

5. The video playback apparatus according to claim 1, wherein the display mode is switched among a first mode for displaying the first video, a second mode for displaying the first video and the second video in an overlaid manner, a third mode for displaying the first video and the second video side by side, and a fourth mode for displaying the second video.

6. The video playback apparatus according to claim 1, further including an image capturing unit configured to capture a video.

7. The video playback apparatus according to claim 6, wherein the processor is further configured to record the captured second video.

8. The video playback apparatus according to claim 1, wherein the processor is further configured to
set a marker for designating a playback position on a playback time of the first video, and
play back the first video and the second video from the playback position at which the marker is set in the playback time of the first video.

9. The video playback apparatus according to claim 1, wherein the processor is further configured to
set a section in which a loop is designated on a playback time of the first video, and
repeat playback of the first video and the second video by using, as a playback range, a section in which the loop is designated in the playback time of the first video.

10. The video playback apparatus according to claim 1, wherein the processor is further configured to execute fast-forwarding or rewinding for a first period, or fast-forwarding or rewinding for a second period shorter than the first period.

11. The video playback apparatus according to claim 10, wherein the first period and the second period are set by a user.

12. The video playback apparatus according to claim 1, wherein the first video is a model video in which dance choreography is captured.

13. A video playback apparatus comprising:
a processor configured to:
set a parameter related to a playback state of a first video; and
control a playback state of a second video different from the first video in a display mode including a mode in which the first video and the second video are simultaneously displayed based on setting of the parameter,
wherein the second video is a live video that is captured in real time.

14. A video playback program that causes a computer to execute a process comprising:
setting a parameter related to a playback state of a first video; and
controlling a playback state of a second video different from the first video in a display mode including a mode in which the first video and the second video are simultaneously displayed based on setting of the parameter,
wherein playback timings of the first video and the second video are identified by time codes of the same music.
